(19) United States
(12) Patent Application Publication
(10) Pub. No.: US 2005/0114703 A1
(43) Pub. Date: May 26, 2005

(54) Multi-purpose electronic kiosk

(75) Inventors: Richard J. Allen JR., Milltown, NJ (US); Andrew C. Karr, Little Silver, NJ (US); Mark Barbaro, Wading River, NY (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Silver Line Building Products Corp., North Brunswick, NJ (US)

(21) Appl. No.: 10/722,788

(22) Filed: Nov. 26, 2003

(51) Int. Cl. H04L 9/00

(52) U.S. Cl. 713/201

(57) ABSTRACT

An electronic kiosk provides differentiated sales-oriented interactive information services to a plurality of different classes of users such as consumers, contractors and salespersons. The kiosk includes a computing system, a first user application and a second user application. The first and second user applications are executable on the computing system and are operable to provide first and second sales-oriented interactive information services to a first group of users and to a second group of users, respectively. At least some of the first and second interactive information services are different from each other. The computing system is further operable to permit only a defined group of user applications including the first user application and the second user application to be executed thereon.

### BACKGROUND OF THE INVENTION

The present invention relates to an electronic kiosk.

For various reasons, in many industries a greater variety of products are available for sale to customers on a greater variety of terms than ever before. Because of this, efforts to increase sales has shifted from past approaches of promoting relatively few products to offering complete lines of products and improving the flow of information about one's products to customers.

This shift in sales patterns has appeared particularly strong in sales of building materials such as millwork. As used herein, millwork includes windows, window sashes, window accessories such as grilles and muntin bars, and doors, trim, moldings and the like, as fabricated of any suitable material including, without limitation, vinyl, wood, or metal (e.g. aluminum) or combination thereof.

Millwork is sold in a variety of outlets including direct from the manufacturer, or by distributor, contractor, and retail home center stores such as The Home Depot® (trade mark of Home Depot, Inc.). In recent years, the choices of millwork available to customers at home center stores has greatly increased, making the customer's job of choosing products more difficult. The job of the store and of the supplier to the store to inform the customer as to available choices and terms has also become more difficult. In stores such as The Home Depot, it has been common for some salespersons to be trained in particular classes of products and product lines (e.g. millwork). Such salespersons require special training to better assist the customer in choosing and ordering products, particularly big ticket items, items ordered in quantity for a project and special order items.

Each home center store has limited numbers of salespersons trained in particular classes of products and product lines, such that the customer sometimes must wait in line for information regarding particular products. The information provided by the salesperson has tended to be static, in the form of paper brochures and the like, such that the customer does not obtain an accurate real-time view of the offerings of a particular supplier such as a millwork manufacturer. Inquiries by telephone or other methods, such as e-mail, must sometimes be made after the customer returns home or by the salesperson to the supplier, to determine the current state of products offered by the supplier, their availability and pricing. When inquiries are made by e-mail, the customer must wait, sometimes until the next day or two, for a response. When inquiries are made by telephone, time and effort must be expended for the customer and the supplier to ensure that they are on the same “page”, i.e., that they are communicating about the same offer of the supplier.

Another way that the customer can obtain information on a supplier's product offerings is through the Internet. The home center store may have a website to which customers can turn for general information about available products. However, the customer typically does not have access to the website when the customer is at the store where products and samples of products are available to be viewed and handled. Moreover, information available through a website of a home center store is typically limited to the products that the home center stocks, and is not as extensive or detailed concerning products in a particular area that interests the customer. Such websites are designed to interest the customer in visiting the home center store, but usually do not provide a complete and accurate view of the products offered at the store.

Suppliers also have websites to which customers can turn for information about their particular product lines. However, again, the customer typically does not have access to such websites when the customer is at the store. If the customer visits a supplier's website prior to visiting the store, the customer may be disappointed upon seeing and handling a product for the first time at the store. The customer may also be disappointed with the available choices and pricing and delivery terms which he first learns upon visiting the store. If the customer visits a supplier's website after traveling to the store, the customer may not have obtained sufficient information concerning the products available from the store and the terms of their sale to continue investigating choices through the website. Comparison shopping can be difficult to do from home over the Internet because the customer may not know the identities of particular suppliers and their product lines that are available at or through the store.

These concerns are especially true in the sale of millwork. Due to limited space, home center stores cannot carry complete lines of millwork from all their suppliers. Accordingly, visits to the store and to the supplier's website often provide very different views of the supplier's products.

It is apparent that merely making computers available to customers at the home center store for browsing supplier websites does not adequately address the above concerns. The websites of suppliers generally cannot provide real-time pricing and discount information and up-to-date inventory status for products offered at the home center store. Supplier websites generally do not distinguish between the products which are available at a particular home center store, and those which are only available through other outlets such as direct from the manufacturer. Also, the websites of different suppliers may not provide consistent and complete information concerning their respective products such that the products can be properly compared. In addition, despite the home center store making computers available to customers for the purpose of them obtaining information to make purchases, such computers are likely to be misused by customers and personnel for visiting websites unrelated to such purchases, and spending time online for recreation instead of obtaining information to assist the purchasing decision.

In addition, some supplier websites may avoid including video clips for various considerations such as storage and network bandwidth requirements. However, in the sale of building materials, video clips that demonstrate how to measure for and install items such as millwork items can be invaluable. It would be desirable to provide such video clips on an on-demand basis to customers while present at a store.

Due to the above-noted concerns, it is apparent that the customer must spend substantial time and effort to obtain sufficient information to select products and identify acceptable terms for purchasing them from a store or supplier to the store.

Many stores, especially home center stores, offer special sales support to a particular class of customers, for example, construction and remodeling contractors. Contractors generally buy in larger quantities and more frequently than retail customers. Contractors are particularly concerned with pricing and availability of products, since unexpected price increases can cut into profits. Delayed availability can slow the contractor's progress on projects. Because of their volume business, special consideration should be given to the particular needs of contractors, so that contractors do not seek out other stores to meet their needs. It is desirable to reward contractors for the volume of purchases they make through the home center store as an added incentive to retain their business.

In addition, the home center store needs to educate its sales force to better assist customers in obtaining the information they need to make purchases. A properly educated sales force can make the difference between satisfying the customer's need for information, and the customer leaving the home center store unsatisfied, seeking to buy elsewhere. Both the home center store and the supplier stand to lose a sale when the customer is not given sufficient information.

Accordingly, it would be desirable to make a greater amount of information available to the customer when the customer is present at a store, especially a store which stocks products or holds samples of available products.

From the viewpoint of both the home center store and the supplier, it would be desirable to provide an improved way of interactively delivering differentiated sales-oriented information to different classes of customers such as consumers and contractors.

It would further be desirable to provide an improved way of educating salespersons at a store so that they can better assist customers in their purchasing decisions.

### SUMMARY OF THE INVENTION

Accordingly, an electronic kiosk and a method of providing interactive information services are provided according to aspects of the invention. Interactive information services, oriented to sales, are provided through a kiosk located at a store to inform users such as consumers and contractors as to choices in purchasing merchandise and as to the terms of the purchase. According to a particular aspect of the invention, the kiosk is placed in proximity to merchandise, such as building materials. Consumers and contractors obtain information specific to their particular needs through differentiated interactive services provided by the kiosk. In addition, salespersons obtain information specific to their particular needs, such as training specific to the store and their particular jobs, and training specific to particular product lines offered by the store.

According to an aspect of the invention, an electronic kiosk provides differentiated sales-oriented interactive information services to a plurality of different classes of users. The kiosk includes a computing system, a first user application and a second user application. The first and second user applications are executable on the computing system and are operable to provide first and second sales-oriented interactive information services to a first group of users and to a second group of users, respectively. At least some of the first and second interactive information services are different from each other. The computing system is further operable to permit only a defined group of user applications including the first user application and the second user application to be executed thereon.

According to a particular aspect of the invention, the user can be connected through a telephone operatively coupled to the kiosk or via text messaging to a customer support representative at a remote location. While so connected, the customer representative can mark up the screen display presented to the user by the user application. For example, the customer support representative can circle, underline, fill in or highlight an area of the screen display presented to the user.

According to another aspect of the invention, an electronic kiosk is provided for placement at a location where building materials are offered for sale, the kiosk providing differentiated sales-oriented interactive information services to a plurality of different classes of users. Such kiosk includes a computing system and a first user application executable on the computing system, the user application being operable to provide first interactive information services to a first group of users including customers. The first interactive information services are oriented to sales of building materials. The first user application further includes documents retrieved from storage at server computers operated for a plurality of respective independent suppliers of the building materials.

A second user application is executable on the computing system and operable to provide second interactive information services to a second group of users including salespersons, the second interactive information services being oriented sales of the building materials. The second interactive information services have functions of educating the salesperson users and tracking attainment of educational goals by individual salesperson users.

The computing system is further operable to permit only a defined group of user applications including the first user application and the second user application to be executed thereon.

### BRIEF DESCRIPTION OF THE DRAWINGS

FIG. 1 is an elevation view of an electronic kiosk according to an embodiment of the invention.

FIG. 2 is a block and schematic diagram illustrating the functional organization of a computing system of an electronic kiosk and its interconnection with other supporting computers.

FIGS. 3 through 12 are diagrams illustrating exemplary screens that are displayed in operation of an electronic kiosk according to various embodiments of the invention.

FIGS. 13 through 15 are functional diagrams illustrating particular information services provided by an electronic kiosk according to particular embodiments of the invention.

### DETAILED DESCRIPTION

Preferred embodiments of an electronic kiosk are described herein, the kiosk providing sales-oriented interactive information services which are specific to different classes of users. Interactive information services are provided in a differentiated manner to users depending on their status as consumers, contractors or salespersons. In such manner, the particular information needs of contractors and those of salespersons are addressed differently than those of consumers. Interactive information services are provided specific to salesperson users to address the particular educational needs of salespersons.

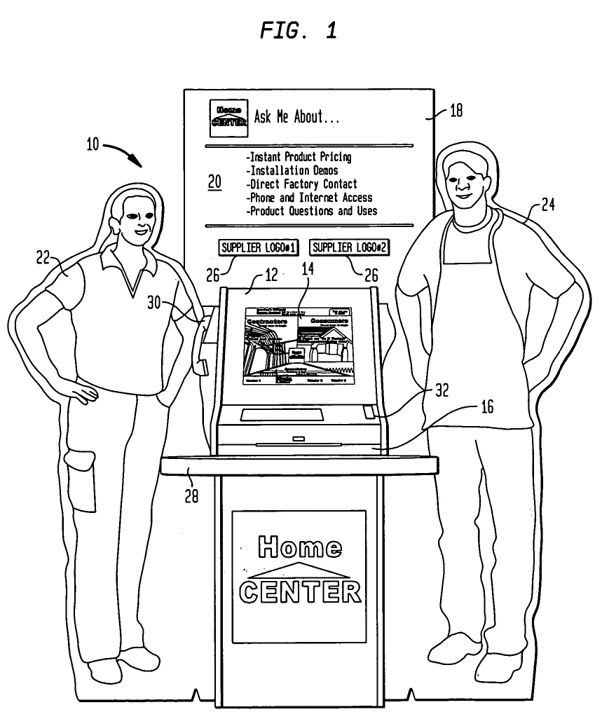

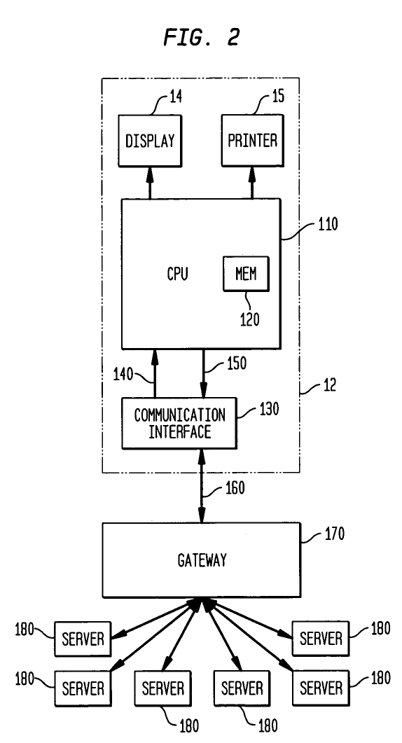

FIG. 1 is an elevation view of a multi-purpose electronic kiosk 10 provided according to a preferred embodiment of the invention. As illustrated in FIG. 1, the kiosk includes a computing system 12 having a display 14 mounted to a stand 16 such that it can be comfortably used from a standing position. The kiosk also includes a printer 15 (FIG. 2) for printing documents accessed by the computing system 12. In an embodiment, the printer 15 has a feature by which a document printed thereon is retracted back into the printer if it is not retrieved within a limited time interval such as five minutes.

Desirably, a display panel 18, including a back-panel (hidden from view), top-panel 20 and left and right side wings 22, 24, is affixed or placed together with the kiosk 10, providing space for signs, slogans or other imprints that draw attention to the kiosk and its uses. The names 26 of suppliers whose products are supported by the kiosk can be imprinted on the display panel, for example. Desirably, the kiosk 10 is located within or on premises of a store near one or more articles of building materials for sale, the kiosk providing interactive information services oriented to sales of the articles, or sales of similar articles.

The display 14 of the computing system 12 is preferably of the touch-screen type to permit interaction by the user without requiring use of a keyboard and/or mouse. Whether or not the display 14 is of the touch screen type, a keyboard, and a cursor-pointing device, e.g. trackball, mouse, or cursor touch pad, may be provided as a primary or alternative interface for interacting with the computing system. A supporting surface 28 may also be located at or affixed to the stand 16 to provide a surface upon which materials and/or notepads, and personal items, etc., can be placed during use of the kiosk. In addition, in an embodiment, the kiosk includes a telephone 30, through which the user can be connected to a live customer support representative, as will be described further below.

In an embodiment, as shown in FIG. 2, the computing system 12 includes a central processor unit (CPU) 110 having an memory or storage 120, the CPU being connected via a bus or connectors 140, 150 to a communication interface 130. The communication interface 130 is connected via a communication channel 160 to a gateway computer 170 for controlling communications between the computing system 12 and server computers 180 remote from the computing system 12. In a preferred embodiment, the gateway computer 170 is as typically provided by an Internet service provider, namely, as a go-between computer for routing communications from and to the computing system 12 of the kiosk 10. The communication channel 160 is desirably of the type which supports a high-speed Internet connection, such as, but not limited to a T1 line, digital subscriber line, cable modem or satellite modem. Alternatively, the communication channel can be a telephone line operable to provide dial-up Internet access.

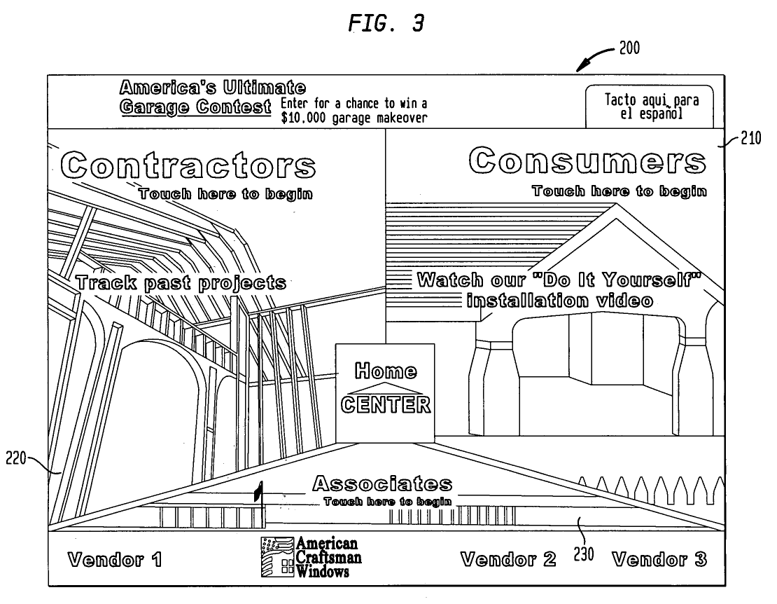

As stated above, the computing system 12 stores and executes a plurality of user applications for providing differentiated interactive information services. As illustrated in FIG. 3, the plurality of user applications are desirably available through a common screen, displayable on display 14, the common screen 200 providing a “home page” for entry into each user application. In the following description of particular embodiments of the invention, the information displayable on the display 14 as screens of each user application is also printable on printer 15. In addition thereto, other information available through a user application can be printed on printer 15, even though it might not be displayed on the display 14. Desirably, a first user application, accessed through screen portion 210, provides interactive information services oriented to sales of building materials to consumers. Desirably, the information services are oriented to selling a particular type of building materials. In an embodiment, the interactive information services are oriented towards sales of millwork. The sales of millwork, including windows, doors, and other items, as defined above, are particularly served by interactive information services targeted to such sales.

A second user application, accessed through screen portion 220, provides interactive information services oriented to sales of building materials to contractors. A third user application, accessed through screen portion 230, provides interactive information services oriented to educating salespersons assigned to sell particular building materials. At least two of the user applications are available to be executed by the kiosk in various combinations. Preferably all three of the user applications particularly described herein are available to be executed. Desirably, the computing system permits only the user applications of a defined group of user applications to be executed. In such manner, use of the kiosk for other than its intended sales-oriented purposes can be precluded.

The particular interactive services that are provided to users of each of the first, second and third user applications vary, at least in part. For example, the first user application, being oriented to consumer sales, is focused on educating the consumer as to the available selection and installation of the building materials. Many consumers using the kiosk buy building materials with the intention of installing the materials themselves.

On the other hand, at least some of the interactive services provided by the second user application are specific to the needs of contractors. Desirably, the interactive information services are provided in a way that is specific to individual contractors. In such embodiment, the contractor user of the kiosk is given an access card or device, alphanumeric user identification (userid) and/or user number which permits him to access information specific to his account at the store or a supplier. Without limitation, the access card can have a magnetic stripe similar to ATM (automated teller machine) cards and credit cards. Alternatively, the access card can include a radio frequency identification tag (RFID), or be bar-coded in such manner to permit the contractor to quickly provide an identifying credential to the computing system, as by swiping the card through a card reader 32 (FIG. 1) coupled to the computing system. After receiving the identifying credential, the computing system authenticates the identifying credential and allows the contractor to access information specific to his account. In addition, the contractor is provided general access to the interactive information services of the second user application.

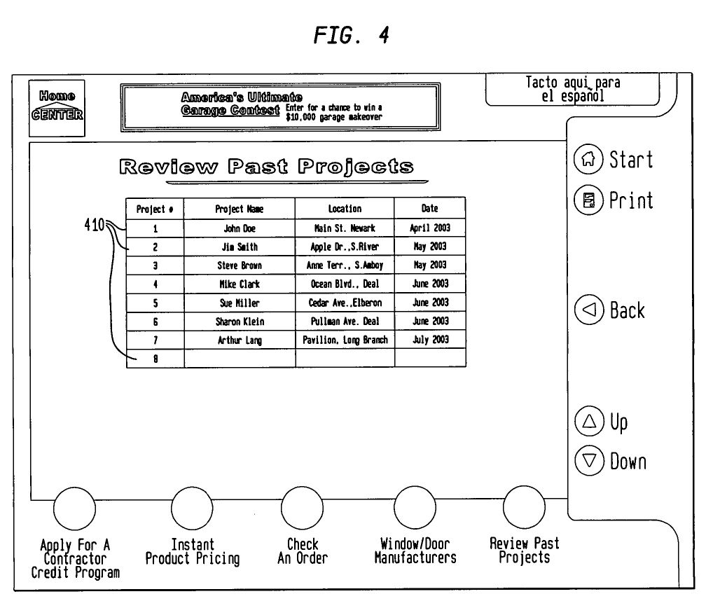

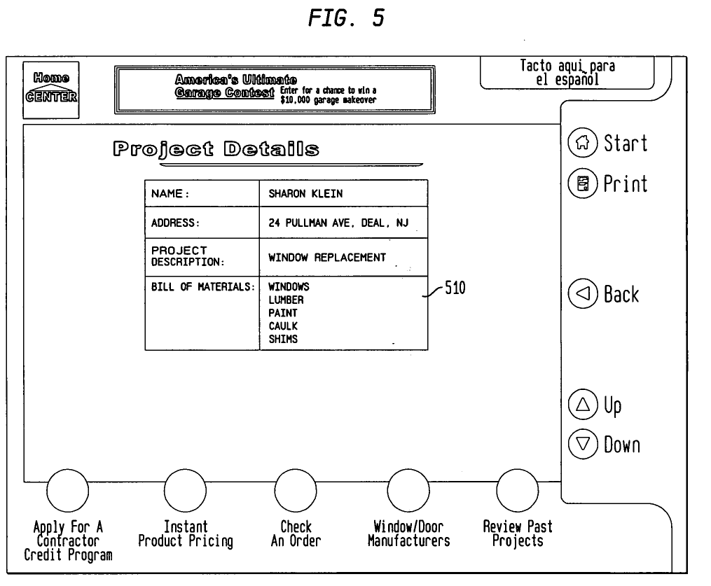

A variety of information specific to the individual contractor can be provided by the second user application upon authentication of the contractor's identifying credential. For example, the second user application can include documents having information regarding the contractor's past projects, for display as images on the display 14 in a format such as illustrated in FIGS. 4 and 5. The displayed documents can also be printed on the printer 15 of the kiosk. Alternatively, documents available through the user application are printable on printer 15 without first displaying them on the display 14.

Such past projects represent orders placed by the contractor with the store or supplier relating to particular projects 410. The displayed information desirably includes bills of materials 510 for each of the contractor's past projects, as shown in FIG. 5. The user application permits the contractor to place a further order by updating one or more bills of materials used on past projects to suit the present project, and by updating the pricing for each of the items listed in the bill of materials. Instant pricing is desirably provided through a pricing system implemented by commercially available software. When the contractor engages in similar projects, he can more readily determine the materials needed for a project by modifying a bill of materials from a prior project. In such manner, the contractor can more quickly obtain an estimate of his costs to procure materials for the present project, and then decide how much to charge the client for the project.

In another example, the second user application may be used to indicate the status of a contractor rewards program. To invite the contractor's loyalty, the store can offer rewards when the contractor surpasses particular purchasing milestones. For example, the store can reward the contractor for placing orders which exceed a particular dollar amount of which exceed a target number of orders. In each case, the second user application can provide an interface indicating the contractor's progress towards goals of the rewards program.

In an exemplary embodiment, user applications including the first, second, and third user applications are stored and provided on the computing system as a plurality of linked documents which reference each other through hyperlinks embedded within the documents. Desirably, the documents are encoded in the form of HTML (hypertext markup language) documents (pages), having links to each other or to other documents embedded therein in the form of URLs (universal resource locators). As such, the documents can be viewed by a facility such as an HTML browser program, examples of which include Internet Explorer® provided by Microsoft Corp. and Netscape Navigator® available from Netscape Communications Corporation. Such linked documents may contain images, instructions for displaying video clips and/or forms for inputting alpha-numeric information, such as provided for the purpose of obtaining more detailed information regarding products. The user applications provided by the kiosk are desirably provided in a manner similar to the way that websites are provided.

In addition, the linked documents of each user application are desirably retrieved from storage remote from the electronic kiosk, such storage being associated with a server computer 180 (FIG. 2), for instance. This too follows the pattern typically employed for providing Internet services over a network in which each of a vast number of user computers can request the downloading of web pages stored on a server computer for display and execution on the user computer.

However, the electronic kiosk is not available as a platform for providing general Internet services to the customer. The user applications that can be stored and executed by the computing system are limited to a defined group of applications only, among which are the first, second and third user applications. Preferred ways for limiting the user applications that can be retrieved for execution at the kiosk include blocking the browser from accepting direct user entry of web addresses, and blocking the browser from issuing requests to download pages from all but particularly identified sites at which the user applications from the defined group are stored. Another way the computing system can limit the user applications to be retrieved for execution is to block all access to sites except for those which are accessible through hypertext links embedded in the linked documents.

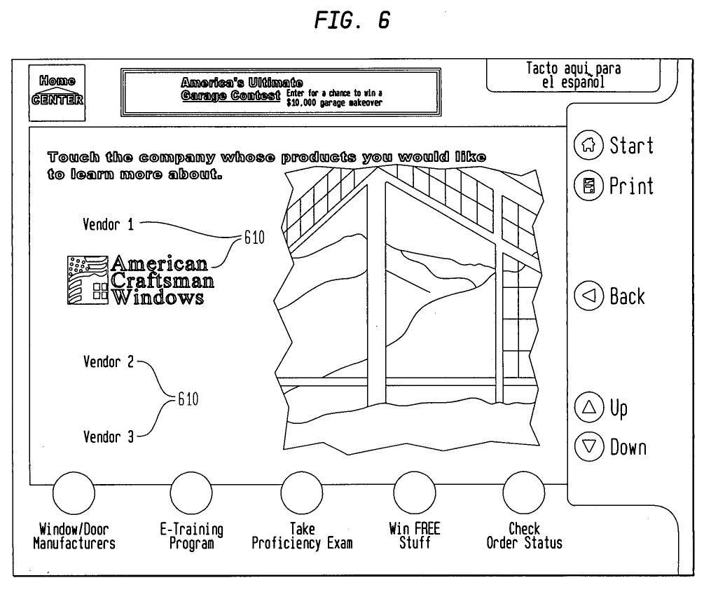

In a particular embodiment of the invention, some portions of one or more of the user applications provide interactive information services specific to particular independent suppliers. A screen display providing access to such supplier specific services is illustrated in FIG. 6. Areas 610 of the screen provide access to particular supplier information when selected by the user. Preferably, in such embodiment, documents (pages) of the user application are retrieved from server computers (FIG. 1) operated for the independent suppliers. For example, a user application directed to the consumer and oriented to sales of millwork can include documents that are stored and retrieved from server computers on which websites of independent millwork suppliers are respectively stored.

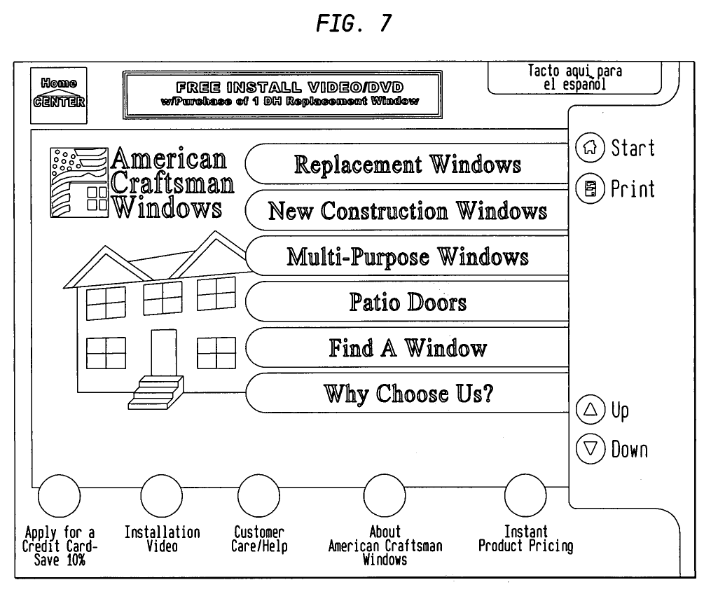

In a particular embodiment illustrated by the screen display shown in FIG. 7, specific to a supplier, documents contain the same or substantially the same information as documents on a website belonging to the supplier. However, the information can be presented in a way specific to the kiosk. For example, the documents of the user application can refer to source documents and/or databases available through the websites of independent suppliers, such source documents and/or databases being used to generate the particular documents which are then displayed on the kiosk 10.

In a particular embodiment, product pricing information is provided to users upon execution of one or more of the user applications by the computing system. Preferably, such product pricing is provided on an instant basis, as by a service enabled by any of several commercially available software systems. In addition, the product pricing information is desirably variable based on one or more factors such as the order quantity, status of the user as contractor, prior purchase by the user, and amount of inventory available for sale. The store may find that variations in such factors from one order to another favor changes in pricing and/or discounts offered to customers, to assist the store in maximizing sales.

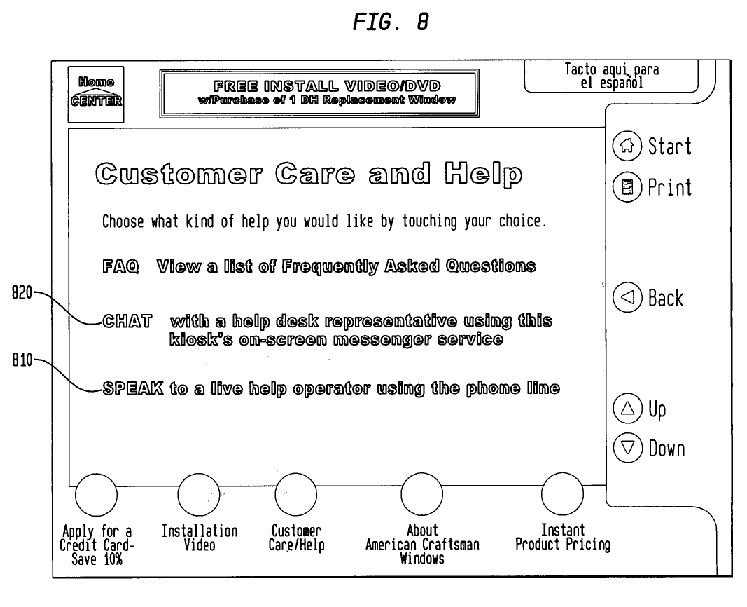

User applications include much information that is unfamiliar to the user, such that the user may desire additional customer support in order to obtain the benefit of the information provided on the kiosk. In such case, the telephone 30 (FIG. 1) provides a handy way of communicating with a customer support representative of either the store or an independent supplier, to obtain assistance in using the user application. In an embodiment, the user application is encoded with dialing instructions so as to connect the user to a customer support representative who is appropriate for the portion of the user application currently executed and displayed by the kiosk 10. As an example, when the user navigates to a point in the user application at which information specific to an independent supplier is displayed, removal of the telephone receiver from the switchhook results in establishment of a live two-way telephonic connection between the user and a customer support representative who can be at a remote location, such as at a call center of the independent supplier. In an embodiment as illustrated in FIG. 8, the user may touch or click a button 810 on the display to initiate the telephonic connection.

Alternatively, live two-way communication need not be established telephonically, but instead can be established through an instant messaging service provided over a network to which the computing system is connected. In such case, as illustrated in FIG. 8, the user needs only to touch or click a button 820 on the display to initiate a live instant messaging session with the customer support representative.

In a particular embodiment, once the user and customer support representative are connected for live two-way communication, each of the two can operate and view the same document of the user application, helping the customer support representative to more quickly understand and resolve the user's question or need. An application sharing program such as Lotus Instant Messaging and Web Conferencing™, available from International Business Machines Corporation, or other similar program can be used to transmit images of the user application as executed at the kiosk to a call center where the customer support representative is located, or vice versa. In such manner, any information entered by the user into a document of the user application is available for transmission from the kiosk to the call center where the representative is located.

In an alternative implementation, the user inputs information into text entry blocks of a document of the user application, which results in the inputted information being stored on a server computer attached to the computing system through a communication channel. In such case, a shared session can be established between the computing system of the kiosk, the server computer and the computer used by the customer representative at the call center which permits the kiosk user and the customer representative to view the same documents including the same information that was inputted by the user into text entry portions of the documents.

Alternatively, the call center can maintain a copy of the user application or relevant portions thereof, and then less information need be shared between the kiosk and the call center. For example, the information can be limited to identifying the particular document of the user application being executed at the kiosk, in order for the computer used by the customer support representative at the call center to display the same document as the user application being executed at the kiosk.

In any of the above alternatives, it may be desirable for the customer representative to demonstrably indicate to the user particular portions of the screen display at the kiosk that apply to the user's need. To such end, a telestrator can be provided at the kiosk, having at least a transmitting function at the call center computer and a receiving function at the kiosk. As used by the customer representative at the call center remote from the kiosk, the telestrator can mark up the screen displayed on the kiosk. For example, the customer representative can circle, underline, fill-in or highlight words, images, etc., that appear thereon, all being examples, without limitation, of “marking up” a screen display, as the term is used herein.

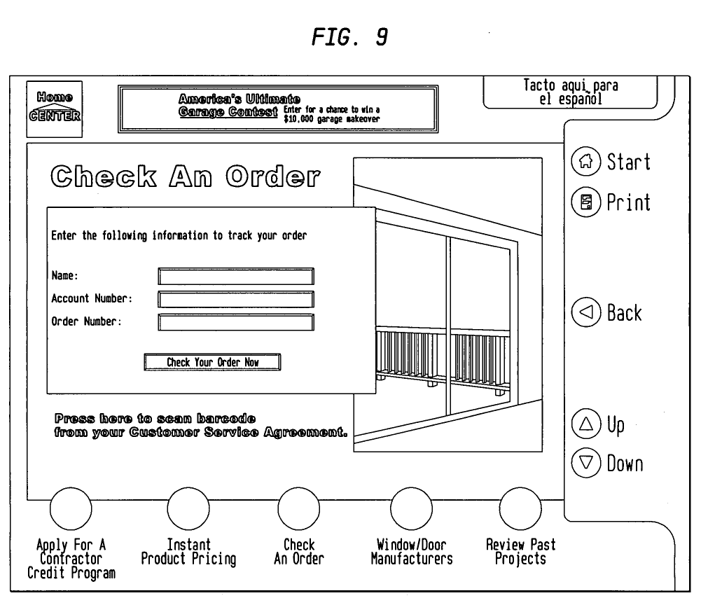

In an embodiment of the invention, the user applications enable individual consumers and contractors to place orders and check on the status of orders already placed, as indicated in the screen display illustrated in FIG. 9. Orders are desirably generated using the pricing information that is provided to the user as described above. When the user is a contractor, the order is desirably placed using the contractor's identifying credential that the contractor submits to gain access to the contractor user application.

Status data regarding submitted orders is maintained on one or more server computers at which a connection can be established from the computing system of the kiosk. Such status data is retrieved by the kiosk computing system for display by the computing system of the kiosk according to a formatted document of the user application.

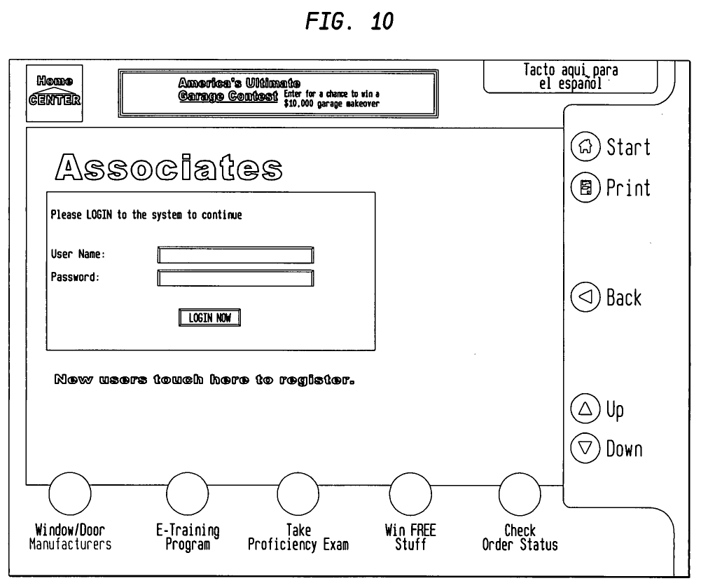

The third user application is oriented specifically to the information needs of salespersons. The third (salesperson) user application desirably limits access to salespersons of the store or the store chain including the particular store. As in the case of the second (contractor) user application, access of the application by salespersons can be granted after the salesperson provides an identifying credential through a card, and the computing system authenticates the credential. Alternatively, the salesperson, a sales “associate”, can gain access by entering a userid and password, as indicated in the screen display illustrated in FIG. 10.

As described above, the third user application provides some interactive information services which are oriented to the education of salespersons. Salespersons, commonly referred to as “sales associates” at some stores, need to obtain knowledge of products and their role at the store through education, and need to refresh their knowledge from time to time as well, such as when changes in product offerings at the store and or store policies occur.

Some home center stores remain open for long hours of the day, for example, from 6 a.m. until 10 p.m. on five or more days per week. During the long open hours of the store, it is common for there to be slower periods in which relatively few customers visit the store. While the kiosk can be used at any time for various purposes, the kiosk according to an embodiment of the invention is available for use during such slower periods to provide interactive information services for the education of salespersons at the store.

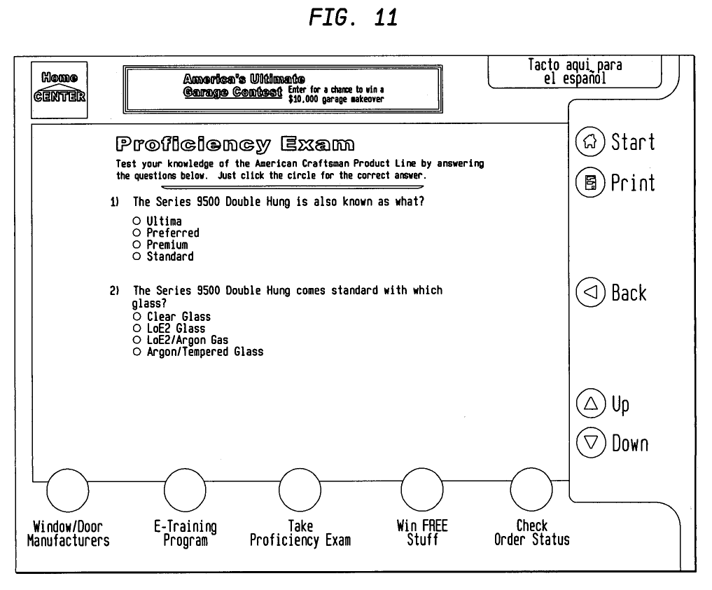

Thus, the third user application also provides interactive educational modules as one aspect of the salesperson-specific interactive information services. In a particular embodiment, the third user application tests the knowledge of the salesperson user, as illustrated by the screen display shown in FIG. 11. Such testing is desirably conducted in conjunction with providing educational modules, as a way of reinforcing the knowledge that has just been imparted by way of the educational modules. Failure to score sufficiently high on a test can result in the salesperson needing to repeat an educational module or take one or more other educational modules designed to improve the salesperson's knowledge.

In addition, the third user application can track the status of individual salespersons in attaining educational goals through such educational modules or other educational opportunities that are provided to the salesperson. Status is desirably maintained on a server computer remote from the computing systems of a plurality of kiosks operably connectable thereto, so as to provide a centralized repository for such information, available on all kiosks.

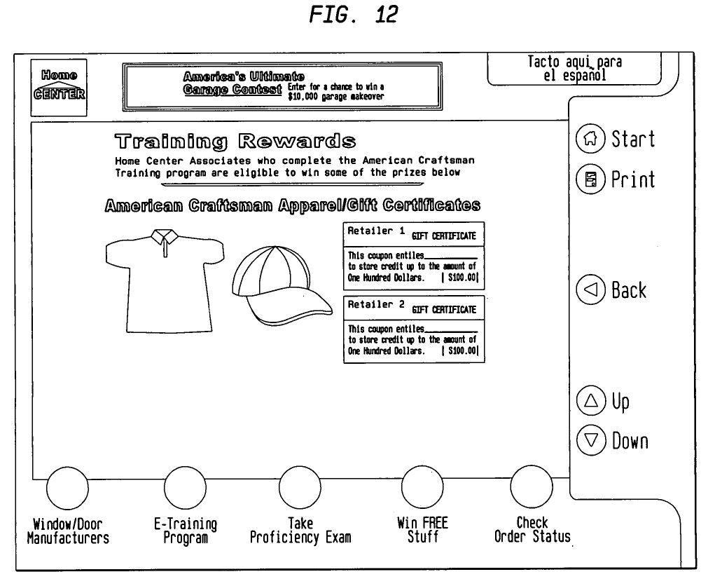

In a further embodiment, the third user application has the ability to display information concerning the progress of the salesperson towards reaching goals of a rewards program oriented to the salespersons. Such rewards program may be designed to reward particular salespersons who meet or exceed sales goals and/or to reward salespersons for attaining knowledge of product offerings and information specific to operation of the store. The particular rewards available for completing a unit of training are highlighted to the salesperson, as illustrated in FIG. 12. Again, such information concerning progress in the rewards program is desirably maintained on a server computer remote from the computing systems of a plurality of kiosks connectable thereto, so as to provide a centralized repository for such information, available on all such kiosks.

In a further embodiment of the invention, one or more of the user applications is operable to display one or more video clips on the display 14 of the kiosk. Desirably, such video clips are retrievable or downloadable from remote storage at one or more server computers accessible by the computing system of the kiosk. In order to maintain the content of such video clips current at each kiosk, a scheduling program can be provided on a plurality of kiosks or server computer for the purpose of copying video clips from the server computer to kiosks. Such scheduling program desirably causes such copying to be performed during periods in which the kiosks are either not being used (e.g. when the store is closed) or during slower periods of use, so as to minimize the impact on operation of the kiosk when copying video clips which may include a large data quantity (e.g. several megabytes to hundreds of megabytes or more).

As an example of the content of such videos, the video clips can demonstrate product installation, e.g., the installation of millwork items such as windows and doors. As another example, videos can be provided through the third (salesperson) user application for the purpose of educating salespersons.

In addition to the installation information provided by video, installation information can be provided as one or more printed documents output from the printer 15. Such printed information is desirably detailed and can even include specific information regarding the installation of a product selected by the user. In a particular embodiment, the printed information includes information inputted by the user to the computing system 12 and/or information retrieved by the computing system based on the inputted information. For example, specific information regarding the installation of windows of a particular type and size can be provided in the printout, including installation tips for the particular location where the windows are installed, as indicated by user input.

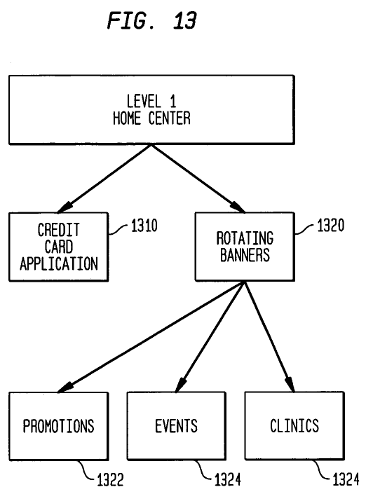

A particular embodiment of the invention of a kiosk oriented towards sales of millwork will now be described with respect to the functional block diagrams of FIGS. 13 through 15. The user applications available through the kiosk are provided at different levels of detail, with the lowest level, Level 1, relating to information that is common to each of the different user applications. The information available at Level 1 is indicated in FIG. 13. As shown therein, such information includes a button and/or other link 1310 to documents permitting the user to apply for a credit card. In addition, Level 1 also provides a set 1310 of banners for display in areas of the screen display that are desirably common to documents of each user application. Such banners rotate between the display of one banner and another at timed intervals of operation so as to vary the content of the displayed banner, as well as to catch the user's eye. Such banners may rotate between content as to promotions 1322, events 1324 and clinics 1326, for example. The rotating banners displayed at kiosks of a particular store can be different from those displayed at other stores, according to particular promotions geared to a particular store or region in which the store is located. As the content of such banners is desirably maintained centrally at a server computer of the store chain which stores and maintains the user applications, such variation in the banners displayed at a particular store or kiosk of a store can be obtained by varying link parameters at the kiosk such that different content is accessed for display on the kiosk.

In a particular example, a rotating banner displays information particular to a promotion at the store or store chain, such as a free set of driver heads to everyone who buys a cordless screwdriver on a particular day. In an embodiment, a promotion is run by way of a particular rotating banner provided to all the kiosks of all stores in the store chain. In another embodiment, a specific promotion is run by way of displaying a particular rotating banner in only the kiosks of particular stores, e.g. only those stores within a particular region such as the Southeast, Southwest, Midwest, Northwest or Northeast. In another variant, a particular banner is displayed only on the kiosks of a particular store.

In addition, the duration of a promotion can vary from store to store, or from region to region. Thus, a promotion can run by way of the rotating banner for a day or a portion of a day in one store, and run for two days, three days, or another length of time in other stores. In still another variation, the content of the banners is varied between particular kiosks of a store. In yet another variation, the content of the banners is varied between the locations of the store that particular kiosks occupy within the chain of stores. For example, a first kiosk is located in the millwork section of stores and a second kiosk is located in the plumbing fixture section of stores. In a particular embodiment, the promotional banners displayed on the millwork location kiosks are different from the promotional banners displayed on the plumbing fixture location kiosks.

One way to vary the promotional content of the banners displayed on each kiosk, store or region is to have each of the kiosks' computing systems (FIG. 2) assigned an identifier such as an Internet Protocol (IP) address. Then, content provided by one or more servers 180 is differentiated based on the kiosk's identifier, e.g., its IP address. For maximum granularity for selecting a kiosk for displaying the banner, such IP address is desirably unique to each kiosk. However, the identifier can be unique only to a group of kiosks such as those particular to a store, if such level of granularity is not needed.

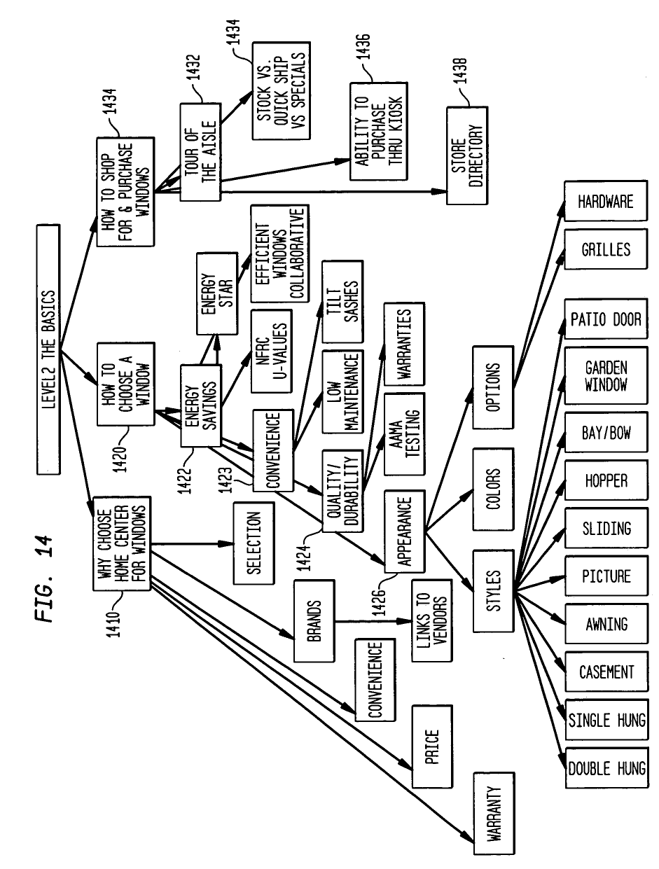

A second level, Level 2, of information, that user applications of the millwork kiosk provide is illustrated in FIG. 14. As illustrated therein, three main areas of information are provided at this level, one area 1410 directed to the strengths of the store, another 1420 directed to helping the user select an appropriate window, and another 1430 directed to help in shopping for a window.

Area 1420 includes many different linked documents (pages) of information that the user can navigate between which relate to various considerations for choosing a particular window, such as energy savings 1422, convenience 1423, quality and durability 1424, and appearance 1426.

Area 1430 educates the user about how windows can be purchased through the store. According to this particular area of detail, the user is invited to view a “tour of the aisle”, as shown at 1432. The user can navigate to that portion of the user application by touching the relevant portion of the touch screen or otherwise clicking a button. Such tour of the aisle is provided by displaying a page on the screen of the kiosk in which the products offered in a particular aisle of the store are featured and indicated as to their location within the aisle. In such manner, the user is directed where to find the particular products offered in that aisle.

Other navigable pages of the user application display other related information such as for communicating to the user the difference between products in stock, those available for quick shipment (i.e. from supplier's inventory), and those products which must be special ordered, as shown at 1434. Other navigable pages can highlight procedures for making purchases through the kiosk, as shown at 1436. The user may also view a store direction 1438 here.

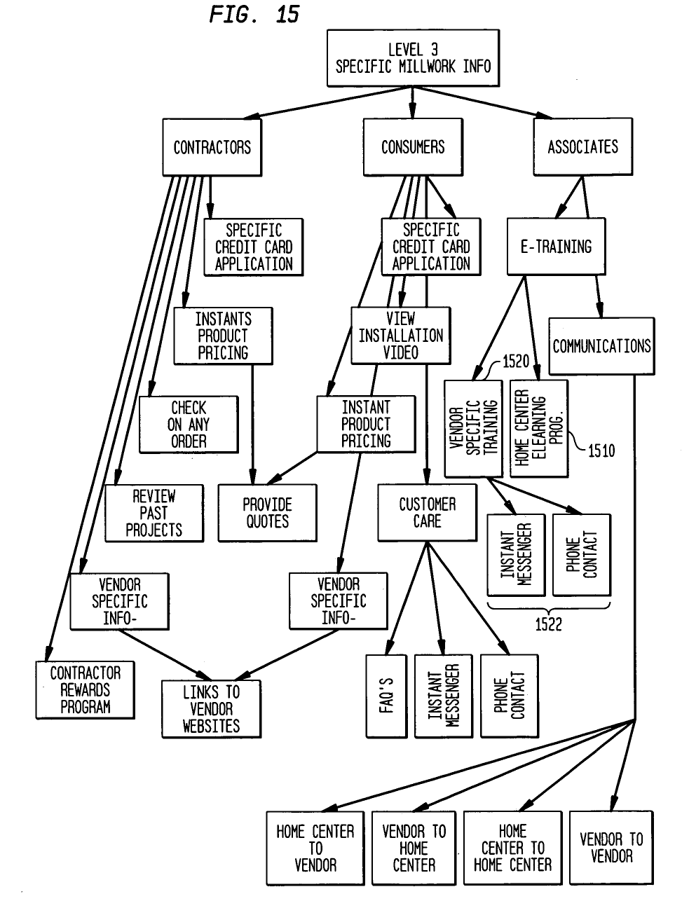

As shown in FIG. 15, at the third level, Level 3, information is provided which is specific to each of three different user applications for contractors, consumers and sales associates (salespersons). Particular features of each user application as already described above are listed in FIG. 15. As particularly shown in FIG. 15, educational modules provided to salespersons include modules specific to general training of the store (1510), and modules specific to the products and procedures related to particular vendors (1520). With respect to such vendor specific training, provision 1522 is made for establishing two-way telephonic and/or instant messaging communication with the vendor, in a manner such as that described above with respect to FIG. 8.

Although the invention herein has been described with reference to particular embodiments, it is to be understood that these embodiments are merely illustrative of the principles and applications of the present invention. Embodiments of the invention are described above with particular reference to three types of user applications: for consumers, for contractors, and for salespeople. In an embodiment of the invention, at least two of the user applications are available to be executed by the kiosk in various combinations, while in a preferred embodiment, all three user applications are available for execution. The terms first user application, second user application and third user application are used to distinguish one user application from another, but are not limiting as to the content of the user application, except as specifically recited in the claims below.

It is therefore to be understood that numerous modifications may be made to the illustrative embodiments and that other arrangements may be devised without departing from the spirit and scope of the present invention as defined by the appended claims.

1. An electronic kiosk operable to provide differentiated sales-oriented interactive information services to a plurality of different classes of users, comprising:
a computing system;
a first user application and a second user application, said first and second user applications executable on said computing system and operable to provide first and second sales-oriented interactive information services to a first group of users and to a second group of users, respectively, at least some of the first and second interactive information services being different from each other,
wherein said computing system is operable to permit only a defined group of user applications including said first user application and said second user application to be executed thereon.

2. An electronic kiosk as claimed in claim 1 wherein said first user application is available to users of the first group and the second group without authentication and said second user application is available to the second group of users only upon authentication.

3. An electronic kiosk as claimed in claim 1 wherein said computing system is further operable to retrieve ones of said defined group of user applications from storage remote from said computing system for execution on said computing system.

4. An electronic kiosk as claimed in claim 3 wherein said computing system limits access to the remote storage to said ones of said defined group of user applications.

5. An electronic kiosk as claimed in claim 1 wherein said interactive information services are oriented towards sales of building materials, the first group of users including consumer customers of the building materials, and the second group of users including contractor customers of the building materials.

6. An electronic kiosk as claimed in claim 5 wherein said building materials consist essentially of millwork.

7. An electronic kiosk as claimed in claim 5 wherein said first user application includes documents containing at least some of the same information as documents of websites belonging to a plurality of respective independent suppliers of the building materials.

8. An electronic kiosk as claimed in claim 7 wherein said documents include at least some documents of websites of said respective independent suppliers of the building materials.

9. An electronic kiosk as claimed in claim 6 wherein said first and second user applications include a plurality of documents stored on server computers managed for a plurality of respective independent suppliers of the building materials.

10. An electronic kiosk as claimed in claim 9 wherein said documents include at least some documents of websites of said respective independent suppliers of the building materials.

11. An electronic kiosk as claimed in claim 5 wherein said defined group of user applications further include a third user application operable provide third sales-oriented interactive information services to a third group of users including salespersons, at least some of the third interactive information services being different from the first and second interactive information services.

12. An electronic kiosk as claimed in claim 11 wherein third sales-oriented interactive information services include interactive educational modules.

13. An electronic kiosk as claimed in claim 12 wherein said third user application tests knowledge of the salesperson user.

14. An electronic kiosk as claimed in claim 13 wherein said third user application tracks attainment of educational goals by the salesperson user.

15. An electronic kiosk as claimed in claim 14 wherein said third user application displays status of a rewards program provided for the salesperson users.

16. An electronic kiosk as claimed in claim 15 wherein the rewards program rewards attainment of educational goals by the salesperson users.

17. An electronic kiosk as claimed in claim 5, wherein said kiosk is disposed at a store near one or more articles of building materials for sale, wherein the interactive information services provided by said first and second user applications provide information oriented to sales of the articles.

18. An electronic kiosk as claimed in claim 7 wherein the first and second user applications are operable to provide price information for the building materials.

19. An electronic kiosk as claimed in claim 18 wherein the price information is variable based on at least one factor selected from order quantity, status of the user as contractor, prior purchase by user, and amount of available inventory.

20. An electronic kiosk as claimed in claim 7 wherein said second user application is operable to display status of a rewards program.

21. An electronic kiosk as claimed in claim 7 wherein said second user application is operable to retrieve a bill of materials for one or more orders placed by the contractor customer and to permit a further order to be placed by modifying the retrieved bill of materials.

22. An electronic kiosk as claimed in claim 7 wherein at least one of said first, second and third user applications is operable to initiate live two-way communication between the user and a customer support representative at a location remote from said kiosk.

23. An electronic kiosk as claimed in claim 22 wherein the live two-way communication includes telephonic communication.

24. An electronic kiosk as claimed in claim 22 wherein the live two-way communication includes text messaging.

25. An electronic kiosk as claimed in claim 22 wherein said user application is further operable to permit the customer support representative to operate said user application and to view the same information displayed to the user by said user application.

26. An electronic kiosk as claimed in claim 22 wherein said user application is further operable to permit the customer support representative to mark up, from the remote location, a screen display presented to the user by said user application.

27. An electronic kiosk as claimed in claim 18 wherein at least one of said first and second user applications is further operable to take an order from a user.

28. An electronic kiosk as claimed in claim 27 wherein said user application is further operable to provide status information regarding an order placed by the user.

29. An electronic kiosk as claimed in claim 11 wherein at least one of said first, second and third user applications is operable to display one or more video clips.

30. An electronic kiosk as claimed in claim 29 wherein the one or more video clips demonstrates an installation technique for at least some of the building materials.

31. An electronic kiosk as claimed in claim 29 wherein the third user application is operable to display the one or more video clips, the one or more video clips having a function of educating the salesperson user.

32. An electronic kiosk as claimed in claim 1 wherein the interactive information services are oriented towards sales of building materials, wherein the first group of users includes consumer customers of the building materials and the second group of users includes salespersons for the building materials.

33. An electronic kiosk as claimed in claim 1 wherein said user application is further operable to permit a person at a remote location to mark up a screen display presented to the user.

34. An electronic kiosk as claimed in claim 1 wherein the interactive information services are oriented towards sales of a category of merchandise, and said kiosk is located in proximity to articles within the category.

35. An electronic kiosk for placement at a location where building materials are offered for sale, the kiosk being operable to provide differentiated sales-oriented interactive information services to a plurality of different classes of users, comprising:
a computing system;
a first user application executable on said computing system and operable to provide first interactive information services to a first group of users including consumers, the first interactive information services being oriented to sales of building materials, said first user application including at least portions retrieved from storage at server computers operated for a plurality of respective independent suppliers of the building materials;
a second user application executable on said computing system and operable to provide second interactive information services to a second group of users including salespersons, the second interactive information services oriented to sales of the building materials and having functions of educating the salesperson users and tracking attainment of educational goals by individual salesperson users,
wherein said computing system is operable to permit only a defined group of user applications including said first user application and said second user application to be executed thereon.

36. An electronic kiosk as claimed in claim 35 wherein said first group of users includes only consumer customers, said electronic kiosk further comprising a third user application executable on the computing system and operable to provide third interactive information services to a third group of users including contractor customers, the third interactive information services being oriented to sales of building materials to the contractor customers, said third user application including at least portions retrieved from storage at server computers operated for a plurality of respective independent suppliers of the building materials, said third user application further being operable to display status of a rewards program for contractor customers.

37. A method of providing differentiated sales-oriented interactive information services through an electronic kiosk to a plurality of different classes of users, comprising:
executing a first user application on a computing system of an electronic kiosk to provide first sales-oriented interactive information services to a first group of users; and
executing a second user application on said computing system to provide second sales-oriented interactive information services to a second group of users, the first and the second user applications being operable through a common interactive user interface of the computing system, at least some of the first and second interactive information services being different from each other, and
restricting the computing system to executing only a defined group of user applications including said first user application and said second user application.

38. A method of providing interactive information services as claimed in claim 37 wherein at least one of said first and second user applications permits a person at a remote location to mark up a screen display presented to the user by said user application.

39. A method of providing interactive information services as claimed in claim 37 wherein the first and second interactive information services are oriented to sales of a category of merchandise, said method further comprising disposing said kiosk in proximity to merchandise articles within the category.

40. A method of providing interactive information services as claimed in claim 37 wherein the first group of users includes consumers and the second group of users includes salespersons.

41. A method of providing interactive information services as claimed in claim 37 wherein the first group of users includes consumers and the second group of users includes contractors.

42. A method of providing interactive information services as claimed in claim 41 further comprising executing a third user application on a computing system of the electronic kiosk to provide third sales-oriented interactive information services to a third group of users including salespersons.

43. A method of providing differentiated interactive information services oriented to sales of building materials through an electronic kiosk to a plurality of different classes of users, comprising:
executing a first user application on a computing system of an electronic kiosk to provide first sales-oriented interactive information services to a first group of users including consumers, the first interactive information services being oriented to sales of building materials, the first user application including at least portions retrieved from storage at server computers operated for a plurality of respective independent suppliers of building materials; and
executing a second user application on said computing system to provide second sales-oriented interactive information services to a second group of users including salespersons, the second interactive information services oriented to sales of building materials and having functions of educating the salesperson users and tracking attainment of educational goals by individual salesperson users; and
restricting the computing system to executing only a defined group of user applications including said first user application and said second user application.

44. An electronic kiosk as claimed in claim 1 wherein said computing system is assigned an identifier, said computing system being further operable to display a rotating banner the content of which is determined based on said identifier.
